(19) United States
(12) Patent Application Publication
(10) Pub. No.: US 2009/0078688 A1
(43) Pub. Date: Mar. 26, 2009

(54) SYSTEM AND METHOD OF OPERATING A WELDING GUN

(75) Inventors: William Richard Giese, Monee, IL (US); Gregory William Bauer, Wilmington, IL (US); Brian Joseph Truesdale, Wauconda, IL (US)

Correspondence Address: MCANDREWS HELD & MALLOY, LTD, 500 WEST MADISON STREET, SUITE 3400, CHICAGO, IL, 60661, US

(73) Assignee: ILLINOIS TOOL WORKS INC., Glenview, IL (US)

(21) Appl. No.: 12/204,263

(22) Filed: Sep. 4, 2008

Related U.S. Application Data
(60) Provisional application No. 60/975,243, filed on Sep. 26, 2007.

(51) Int. Cl. B23K 9/00; B23K 9/10

(52) U.S. Cl. 219/137 R; 219/137.31; 219/136

(57) ABSTRACT

A welding gun includes a handle, an input line, a neck and an acoustic wave trigger. The handle is configured to be grasped by an operator and includes first and second ends. The input line connects to a first end of the handle and is configured to deliver wire and/or gas to the welding gun. The neck is operatively connected to the second end of the handle. The wire and/or gas passes into the neck and out through a nozzle. The acoustic wave trigger is secured to the handle and activates the welding gun when merely touched, as opposed to being squeezed or pressed, by the operator.

### RELATED APPLICATIONS

This application relates to and claims priority benefits from U.S. Provisional Patent Application No. 60/975,243 entitled “Active Touch Switch For Welding Gun,” filed Sep. 16, 2007, which is hereby incorporated by reference in its entirety.

### FIELD OF EMBODIMENTS OF THE INVENTION

Embodiments of the present invention generally relate to welding systems, and more particularly to a trigger or switch of a welding gun.

### BACKGROUND

Welding is used in various manufacturing and construction applications to join metal pieces together to form a unitary piece. An arc welding system typically includes an electric power supply coupled to a welding gun that houses an electrode that is located in the handle. The electrode completes an electrical circuit with a source of power when the electrode is placed against a piece of metal to be welded. The contact between the electrode and the metal piece produces an electric arc between the electrode and the metal piece. The heat of the electric arc is concentrated on the metal piece, or pieces, to be joined, thereby melting the metal piece(s). A filler material is added to the molten metal, which subsequently cools and solidifies, joining the metal pieces together.

Metal Inert Gas (MIG) welding is one type of arc welding. MIG welding is also referred to as “wire-feed” or Gas Metal Arc Welding (GMAW). In MIG welding, a metal wire is used as the electrode to produce the arc. The wire is shielded by an inert gas and the metal wire acts as the filler for the weld. The inert gas is used to shield the electric arc from outside contaminants and gases that may react with the weld. Typically, the wire and gas are fed through a hand-held welding gun. The wire and gas are fed to the welding gun from a welding system having a wire feeder, a power source and a source of gas.

A typical welding gun includes a switch or trigger that is coupled to the rest of the system. The trigger or switch is configured to be actuated by an operator's index finger. The switching mechanism inside the trigger is a conventional open/close contact mechanical switch, having a plurality of mechanical connections and moving parts. When the trigger is actuated, gas and wire are fed through the handle and power is applied to the wire. Typically, the trigger or switch has a spring that is used to bias the trigger to a disengaged position. The force of the spring must be overcome to operate the trigger.

Other types of welding, such as submerged arc welding, utilize wire guns that also include switches or triggers. In submerged arc welding, a trigger is actuated to feed flux and wire through the welding gun. The triggers or switches of typical welding guns include mechanical connections and moving parts, such as springs, stems or the like.

As noted above, in order to operate a typical welding gun, the trigger is engaged. If a relatively long weld is required, the trigger is pressed for as long as the welding gun is activated. That is, the operator pressing the trigger ensures that the welding gun remains in an activated state. However, because the force of the biasing member, such as a spring, of the trigger or switch must be overcome, operation of the welding gun may cause discomfort to a user. For example, an operator's index finger may cramp or, with extended use over a long period of time, develop conditions such as general fatigue, arthritis, or the like.

In order to provide comfortable, extended operation, various welding guns include a trigger locking mechanism so that an operator does not have to constantly press the trigger in order to maintain activation. The locking mechanism is configured to allow for a quick release. Thus, when the operator is finished welding, the operator simply engages the quick release to cease activation. Because the triggers typically include mechanical connections and locking mechanisms, there is a potential for the triggers to malfunction, such as by being inadvertently activated, locked or the like. For example, if the welding gun is dropped, the trigger may be accidentally locked into an activation position. Additionally, various locking mechanisms provide a certain amount of deactivation delay.

### SUMMARY OF EMBODIMENTS OF THE INVENTION

Certain embodiments of the present invention provide a welding gun including a handle configured to be grasped by an operator, an input line, which is configured to deliver one or both of wire and/or gas to the welding gun, connected to a first end of the handle, a neck operatively connected to the second end of the handle, wherein the wire and/or gas passes into the neck and out through a nozzle, and an acoustic wave trigger secured to the handle. Unlike conventional welding gun switches, the acoustic wave trigger may have no moving parts. The acoustic wave trigger activates the welding gun when touched by the operator. That is, the welding gun is activated through a mere touch on the trigger, as opposed to squeezing or pressing the trigger.

The acoustic wave trigger may include a substrate having an acoustic wave cavity and a transducer mounted to the substrate. The transducer is configured to generate a trapped acoustic wave within the acoustic wave cavity. A sensing circuit detects a change in one of impedance or decay rate of the trapped acoustic wave in order to determine if the acoustic wave trigger is being touched.

The acoustic wave trigger may include a modular main body that may be selectively inserted into and removed from the handle. Optionally, the acoustic wave trigger may be an integral part of the handle.

The welding gun may also include a tactile cover positioned over the acoustic wave trigger. The tactile cover provides an engagement surface that is discerned and recognized through touch.

The welding gun may also include at least one acoustic wave switch positioned on the handle. The acoustic wave switch(es) may have no moving parts and are configured to adjust one or more of weld voltage intensity, wire feed and/or gas feed to the welding gun.

Certain embodiments of the present invention provide a method of operating a welding gun that includes contacting a trigger through a touch, activating welding through the contacting, maintaining the activating as long as the contacting, and deactivating the welding when the contacting ceases. The contacting occurs without squeezing or pressing. The activating may occur after a predetermined time of the contacting. The deactivating may occur as soon as the touch loses contact with the trigger.

The method may also include detecting the contacting by measuring a change in impedance or decay rate of a trapped acoustic wave within an acoustic wave cavity of the trigger. Additionally, the method may include controlling one or more of weld voltage intensity, gas feed to the welding gun and/or wire feed to the welding gun by contacting one or more of a plurality of acoustic wave switches secured to the welding gun.

Certain embodiments of the present invention provide a metal inert gas welding system that includes an inert gas cylinder containing inert gas, a source of wire, a power source/feeder connected to the inert gas cylinder and the source of wire, and a welding gun connected to the power source/feeder. The feeder supplies the inert gas and the wire to the welding gun. The welding gun may be similar to the embodiments of the present invention described above.

### BRIEF DESCRIPTION OF SEVERAL VIEWS OF THE DRAWINGS

FIG. 1 illustrates a schematic of a metal inert gas (“MIG”) welding system, according to an embodiment of the present invention.

FIG. 2 illustrates a lateral view of a welding gun, according to an embodiment of the present invention.

FIG. 3 illustrates an isometric, partial cross-sectional view of an acoustic wave trigger, according to an embodiment of the present invention.

FIG. 4 illustrates a flow chart of a method of operating a welding gun, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

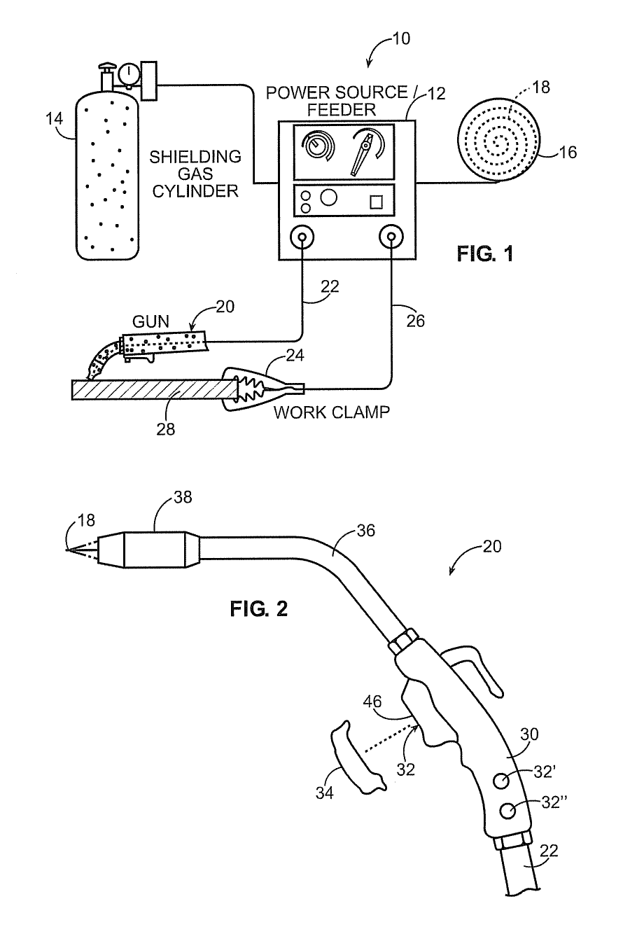

FIG. 1 illustrates a schematic of a metal inert gas (“MIG”) welding system 10, according to an embodiment of the present invention. While FIG. 1 is described with respect to a MIG welding system, embodiments of the present invention may be used with various other welding systems, such as submerged arc welding systems.

The welding system 10 includes a power source/wire feeder 12, a gas cylinder 14 containing a gas, a spool 16 of electrode wire 18 that is coupled to the power source/wire feeder 12, a welding gun 20, a welding cable 22, a work clamp 24 and a ground cable 26. The power source/wire feeder 12 provides electric power to the welding gun 20 via the welding cable 22. Further, the power source/wire feeder 12 directs the feeding of gas and wire 18 to the welding cable 22.

The welding cable 22 routes the gas and the wire 18 to the welding gun 20. The work clamp 24 is clamped onto a conductive workpiece 28 to be welded. The work clamp 24 and the ground cable 26 electrically couple the power source/wire feeder 12 to the workpiece 28.

The welding gun 20 is used to direct the wire to the workpiece 28 and to control the supply of gas and wire 18 from the power source/wire feeder 12 to the workpiece 28. When the wire 18 is touched to the workpiece 28, an electrical circuit is completed. Electricity from the power source/wire feeder 12 flows through the wire 18 and the workpiece 28, thereby producing an arc. The electric arc produces heat that melts the workpiece 28 in a region surrounding the point of contact between the wire 18 and the workpiece 28. The wire 18 also acts as filler material. The heat of the arc melts the wire 18 along with the workpiece 28. The inert gas forms a shield that prevents harmful chemical reactions from occurring at the weld site. When the arc is removed, the workpiece 28 and the filler material solidify, forming the weld. Additional details of the welding system 10 are described in U.S. Pat. No. 7,009,145, entitled “Welding System Having Welding Gun With Self-Contained Locking Trigger,” which is hereby incorporated by reference in its entirety.

FIG. 2 illustrates a lateral view of the welding gun 20. The welding gun 20 includes a handle 30 having an acoustic wave trigger 32. Unlike conventional welding gun triggers, the acoustic wave trigger 32 may include no moving parts. A separate and distinct trigger cover 34 may be removably secured to the acoustic wave trigger 32. The cover 34 may be formed of rubber, plastic or the like and provides a tactile surface that may be configured to emit an audible click when engaged.

The welding cable 22, which is operatively connected to the handle 30, houses control wires that are connected to the acoustic wave trigger 32. The acoustic wave trigger 32 allows an operator to control the supply of gas, wire 18 and power from the power source/wire feeder 12.

In order to activate the welding gun 20, an operator does not need to press the acoustic wave trigger 32. Instead, the operator 32 merely touches (i.e., moves his/her finger into contact with) the acoustic wave trigger 32 or touches the cover 34 so that the cover abuts the acoustic wave trigger 32. A minimal amount of force is needed to engage the acoustic wave trigger 32. Indeed, the operator only moves his/her finger into contact with the a touch surface of the trigger 32, as opposed to pressing (i.e., exerting a relatively large force intended to move) the trigger 32. That is, an operator merely touches the active tough trigger 32 so that a finger (or an underside of the cover 34) abuts a surface of the acoustic wave trigger 32, as further explained below. The operator does not need to squeeze the trigger, as with conventional welding guns.

Alternatively, the welding gun 20 may be configured so that a certain amount of pressure is used to activate the welding gun 20 through the acoustic wave trigger 32. That is, the acoustic wave trigger 32 may be configured to activate the welding gun 20 through a touch of a particular amount of pressure. Contact below that pre-configured pressure would not activate the welding gun 20.

Referring to FIGS. 1 and 2, once the acoustic wave trigger 32 is touched by an operator, an electrical signal is sent from the acoustic wave trigger 32 to the power source/wire feeder 12 (shown in FIG. 1) that directs wire 18 from the spool 16 to be fed through the welding cable 22 to the welding gun 20. Also, electric power from the power source/wire feeder 12 is supplied to the wire 18. The wire 18 and gas are fed through a neck 36 secured to the handle 30 towards the workpiece 28. A nozzle 38 located at a distal end of the neck 36 directs the wire 18 and gas from the neck 36 onto the workpiece 28. As long as the operator continues to touch the acoustic wave trigger 32, or touch the cover 34 so that the cover 34 abuts a surface of the acoustic wave trigger 32, these processes continue. When the operator removes his/her finger from the acoustic wave trigger 32 and/or the cover 34, the acoustic wave trigger 32 immediately ceases activation of the welding gun 20. That is, the wire 18 is no longer fed to the welding gun and electric power from the power source/wire feeder 12 to the wire 18 ceases.

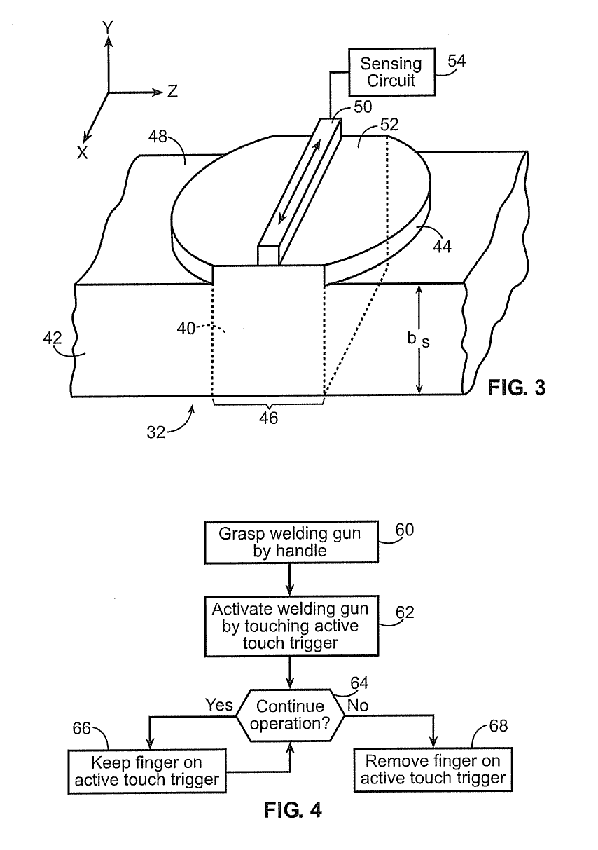

FIG. 3 illustrates an isometric, partial cross-sectional view of the acoustic wave trigger 32, according to an embodiment of the present invention. The acoustic wave trigger 32 includes an associated acoustic wave cavity, or resonator, 40 that extends through the thickness b, of a substrate 42, which may be the main body of the trigger 32 itself. The substrate 42 may be formed of metal, plastic, glass, ceramics, or the like that are capable of supporting a resonant acoustic wave.

The acoustic wave cavity 40 is formed in the substrate 42 such that the mass per unit surface area of the acoustic wave cavity 40 is greater than the mass per unit surface area of the substrate 42 adjacent the acoustic wave cavity 40. In one embodiment, the mass per unit area of the substrate 42 in the trigger engagement region is increased to form the acoustic wave cavity 40 by forming a thin plateau or mesa 44 on a surface of the substrate 42 that is parallel to the plane of the substrate 42 and/or a touch surface 46, which is configured to be engaged by an operator. The mesa 44 may be formed on a back surface 48 of the substrate 42 opposite the touch surface 46 of the acoustic wave cavity 40. In general, the back surface 48 is secured within a receiving hole formed in the handle 30 (shown in FIG. 2) and the touch surface 46 is exposed. Alternatively, the mesa 44 may be formed on the touch surface 46.

A transducer 50, which is located within the handle 30 when the acoustic wave trigger 32 is securely attached to the handle 30, may be mounted on a surface 52 of the acoustic wave cavity 40 to generate an acoustic wave that is substantially trapped or localized within the acoustic wave cavity 40. Although the transducer 50 is shown as being mounted on the mesa 44, if the mesa 44 is formed on the touch surface 46 of the substrate 42, the transducer 50 may be mounted directly on the substrate surface of the acoustic wave cavity 40 opposite the mesa 44 so that the transducer 50 is on the backside of the substrate 42. When the acoustic wave trigger 32 is secured within the handle 30 of the welding gun 20, the transducer 50 is electrically connected to a sensing circuit 54 or separate processing unit within the welding gun 20.

The acoustic wave trigger 32 may use any type of acoustic wave capable of being substantially trapped in the acoustic wave cavity 40. For simplicity, the acoustic wave trigger 32 is described using a shear wave in a direction that is in the plane of the substrate 42, wherein the shear wave energy extends in a direction perpendicular to the plane of the substrate 42, that is, through the thickness of the substrate 42. A shear wave is advantageous because it is insensitive to liquids and other contaminants on the touch surface 46 of the acoustic wave trigger 32. Because the fundamental or zeroth order mode of a horizontally polarized shear wave may not be substantially trapped, higher order shear wave modes are used in accordance with embodiments of the present invention. It should be appreciated that because the acoustic wave used is trapped, the wave is a standing wave. A standing wave has a number of advantages over an acoustic wave that propagates or travels along a path in a substrate. For example, propagating waves are not confined to the main path of propagation but can diffract off of the main path complicating touch detection. This is opposed to a standing wave which by its nature is confined to the area of a particular acoustic wave cavity 40. Because the acoustic wave is confined, touch detection is easily accomplished. Further, the wave energy of a propagating wave is not stored at any location along the path. Once the wave passes a point along the path, the wave is gone, thereby making timing and control critical for touch detection with propagating waves. There are no timing or control issues with a standing wave because the wave energy is stored in the acoustic wave cavity 40. Moreover, a propagating wave is not a resonating wave. As such, the wave energy decays as it travels. A standing wave is resonant so that the wave is reinforced and prolonged. As a result, the standing wave has a much greater amplitude than a wave that is not confined. The construction and operation the acoustic wave cavity 40 is further described in U.S. Pat. No. 7,106,310, entitled “Acoustic Wave Touch Actuated Switch” (The “'310 patent”), which is hereby incorporated by reference in its entirety.

Embodiments of the present invention provide a system and method of detecting pressure and movement with respect to the touch surface 46 of the acoustic wave trigger 32, using acoustic wave energy that employs trapped energy concepts to create localized mechanical resonator, or acoustic wave cavity 40. The '310 patent discloses an acoustic wave switch that includes a substrate with an acoustic wave cavity, or resonator, formed therein such that the mass per unit area of the acoustic cavity is greater than the mass per unit area of the substrate adjacent the acoustic cavity. A transducer is mounted on the acoustic cavity for generating an acoustic wave that is substantially trapped in the cavity. A touch on the touch surface of the acoustic cavity absorbs acoustic wave energy and produces a detectable change in the impedance of the transducer. Moreover, as a user touches the touch surface, the resonant frequency changes, which may be detected by the sensing circuit 54 and/or processing unit which is electrically connected to the transducer.

The acoustic wave trigger 32 has a high Q (the ratio of the stored energy to lost or dissipated energy over a complete cycle) so as to enable a touch to be detected by extremely simple, low-cost circuitry. The acoustic wave trigger 32 is rugged, explosion proof, operates in the presence of liquids and other contaminants, has a lower power consumption and may be incorporated and integrally formed in the handle 30 of the welding gun 20.

The acoustic wave trigger 32 may be connected to an extremely simple touch detection or sensing circuit 54, such as shown and described in the '310 patent. For example, the transducer 50 may be coupled to a multiplexer that sequentially couples the transducer 50 and its associated acoustic wave trigger 32 to an oscillator, as discussed in the '310 patent. Embodiments of the present invention may detect a touch on the touch surface 46 through a detected change in impedance, as described in the '310 patent. Once a touch is detected, the welding gun 20 is activated. Further, as described above, only a touch, but not a squeeze/press, is needed in order to activate the welding gun 20. That is, a change in impedance is detected as soon as contact is made with the touch surface 46. Once contact is made, the welding gun 20 remains active until the operator's finger is removed.

Optionally, embodiments of the present invention may detect a touch on the touch surface 46 by measuring the decay time of the acoustic wave within the acoustic wave cavity 40. United States Patent Application Publication No. 2004/0246239, entitled “Acoustic Wave Touch Detection Circuit and Method” (the “'239 application”) which is hereby incorporated by reference in its entirety, describes a controller that detects a sensed event such as a touch on an acoustic wave switch/sensor based on the decay time. The trapped acoustic wave within the acoustic cavity, or resonator, acts to “ring” the acoustic cavity. That is, as a voltage is applied to the transducer, the transducer operates to resonate the acoustic cavity.

As described in the '239 application, the sensing circuit 54 operatively connected to the acoustic wave trigger 32 may include a controller that drives the transducer 50 to generate a resonant acoustic wave in the acoustic wave cavity 40 during a first portion of a sampling cycle. In a second portion of the sampling cycle, the controller monitors the time that it takes for the acoustic wave signal from the transducer 50 to decay to a predetermined level. Based on the decay time, the controller detects a sensed event, such as a touch on the touch surface 46 of the acoustic wave trigger 32.

Referring to FIGS. 1-3, the acoustic wave trigger 32 formed on, and/or connected to, the handle 30 of the welding gun 20 may be formed and operated similar to the acoustic wave switches shown and described in either the '310 patent or the '239 application. That is, instead of using mechanical triggers that use springs, stems or the like, the touch surface 46 of the acoustic wave trigger 32 is connected to, or part of, an acoustic wave cavity 40 or resonator operatively connected to the transducer 50. The shape and size of each touch surface 46 may be different than shown in FIG. 3.

The sensing circuit 54 may be integrated directly into the acoustic wave trigger 32. The trigger 32 itself may be a modular unit that may be removably secured within a receiving chamber of the handle 30. Thus, a welding gun 20 may be retrofit with the acoustic wave trigger 32. A conventional mechanical switch may be removed from the welding gun, and the acoustic wave trigger 32 may be positioned in its place. The sensing circuit 54 may be configured to provide the same type of activation signals as the conventional mechanical switch. In particular, the sensing circuit 54 may be in communication with the system 10, and when a touch is detected on the touch surface 46, sends a signal to active the welding gun 20.

Because an operator needs to only touch the acoustic wave trigger 32 in order to activate the welding gun 20 (as opposed to squeezing/pressing with enough force to overcome the resistive force of a mechanical trigger), the operator may comfortably operate the welding gun with just a simple touch. Further, for extended operation, a mechanical lock is unnecessary as the operator only needs to maintain contact with the acoustic wave trigger 32 (as opposed to maintaining a sufficient pressing force over an extended period of time, as with conventional triggers). The sensing circuit 54 detects the presence of a touch as change in impedance or decay rate and activates the welding gun 20 accordingly. Further, as soon as the operator removes his/her finger from the touch surface 46, the sensing circuit 54 immediately detects the change in impedance or decay rate and deactivates the welding gun 20. It has been found that because the acoustic wave trigger 32 is capable of such immediate detection, there is no hysteresis or the like that may lead to lag time between an operator attempting to deactivate the welding gun 20, as is the case with conventional triggers.

As shown in FIG. 2, the welding gun 20 may include additional acoustic wave switches 32′ and 32″ that may be used to control various other functions. While the switches 32′ and 32″ are shown on the side of the handle, these switches 32′ and 32″ may be located at various other positions, such as a front or back of the handle. For example, acoustic wave switch 32′ may be used to increase weld voltage intensity, while acoustic wave switch 32″ may be used to decrease weld voltage intensity. The acoustic wave switches 32′ and 32″ detect touches the same way as the acoustic wave trigger 32. The welding gun 20 may include additional acoustic wave switches that may be used to control various other functions of the welding gun and system. For example, additional acoustic wave switches may be used to vary the rate of wire and/or gas feed to the welding gun. Acoustic wave switch 32′, for example, may be used to increase the rate of wire feed to the welding gun, while acoustic wave switch 32″, for example, may be used to decrease the rate of wire feed to the welding gun. In general, the welding gun 20 may include more or less acoustic wave switches 32′ and 32″ at additional and/or different positions than those shown in FIG. 2.

FIG. 4 illustrates a flow chart of a method of operating a welding gun, according to an embodiment of the present invention. At 60, an operator grasps the welding gun by the handle. In order to activate the welding gun, the operator touches the touch surface of the acoustic wave trigger at 62. The operator only needs to touch the surface, as opposed to squeezing/pressing it. The acoustic wave trigger of the welding gun is able to detect a change in impedance or decay rate as soon as the touch surface is touched. At 64, the operator determines how long to maintain operation of the welding gun. If continued operation is desired, the operation keeps his/her finger on the touch surface as long as desired at 66. If operation is to be discontinued, the operator merely removes his/her finger at 68.

Because embodiments of the present invention do not include mechanical locks, they are not susceptible to being inadvertently locked, such as if the welding gun is dropped. Additionally, the acoustic wave trigger and/or switches may be configured to activate the welding gun based on a particular impedance or decay rate change. For example, the acoustic wave trigger and/or switches may be configured to activate the welding gun when an established, predetermined measured change related to a finger touch is sensed, as opposed to that of a floor or object touching the trigger. Further, the acoustic wave trigger may be configured to activate the welding gun after an impedance or decay rate change is sensed for a predetermined period of time (e.g., 5 seconds). Thus, a dropped welding gun causing a change of impedance or decay rate of only a very brief time period will not activate the welding gun. However, once activated, the acoustic wave trigger is configured to deactivate the welding gun as soon as a finger is removed from the trigger.

Embodiments of the present invention provide a welding gun including an acoustic wave trigger that quickly, efficiently and simply detects the presence of a touch. In order to activate a welding gun, an operator merely touches the switch, instead of squeezing/pressing a mechanical switch with sufficient force to overcome the resistive opposing force. The acoustic wave trigger senses a touch as soon as the operator's finger contacts the touch surface. Unlike conventional triggers, embodiments of the present invention do not include a plurality of moving parts, such as springs, stems or the like, that are susceptible to malfunction, damage and general wear and tear over time. Further, embodiments of the present invention allow for extended operation of a welding gun without the need for a mechanical lock having a plurality of moving parts.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A welding gun, comprising:
a handle configured to be grasped by an operator, said handle having first and second ends;
an input line connected to said first end of said handle, said input line configured to deliver one or both of wire and/or gas to the welding gun;
a neck operatively connected to said second end of said handle, wherein the one or both of wire and/or gas passes into said neck and out through a nozzle; and
an acoustic wave trigger secured to said handle, said acoustic wave trigger activating the welding gun when touched by the operator.

2. The welding gun of claim 1, said acoustic wave trigger comprising:
a substrate having an acoustic wave cavity; and
a transducer mounted to said substrate, wherein said transducer is configured to generate a trapped acoustic wave within said acoustic wave cavity.

3. The welding gun of claim 1, said acoustic wave trigger comprising a sensing circuit that detects a change in one of impedance or decay rate of a trapped acoustic wave within said acoustic wave trigger in order to determine if said acoustic wave trigger is being touched.

4. The welding gun of claim 1, wherein the welding gun is activated without squeezing said acoustic wave trigger.

5. The welding gun of claim 1, wherein said acoustic wave trigger comprises a modular main body that may be selectively inserted into and removed from said handle.

6. The welding gun of claim 1, wherein said acoustic wave trigger is an integral part of said handle.

7. The welding gun of claim 1, comprising a tactile cover positioned over said acoustic wave trigger.

8. The welding gun of claim 1, comprising at least one acoustic wave switch positioned on said handle, said at least one acoustic wave switch configured to adjust one or more of weld voltage intensity, wire feed and/or gas feed to the welding gun.

9. A method of operating a welding gun, comprising:
contacting a trigger through a touch;
activating welding through said contacting;
maintaining said activating as long as said contacting; and
deactivating said welding when said contacting ceases and the touch loses contact with the trigger.

10. The method of claim 9, wherein said contacting occurs without squeezing or pressing.

11. The method of claim 9, wherein said activating occurs after a predetermined time of said contacting.

12. The method of claim 9, wherein said deactivating occurs as soon as the touch loses contact with the trigger.

13. The method of claim 9, comprising detecting said contacting by measuring a change in impedance or decay rate of a trapped acoustic wave within an acoustic wave cavity of the trigger.

14. The method of claim 9, comprising controlling one or more of weld voltage intensity, gas feed to the welding gun and/or wire feed to the welding gun by contacting one or more of a plurality of acoustic wave switches secured to the welding gun.

15. The method of claim 9, comprising selectively inserting and removing the trigger from a handle of the welding gun.

16. A metal inert gas welding system, comprising:
an inert gas cylinder containing inert gas;
a source of wire;
a power source/feeder connected to said inert gas cylinder and said source of wire; and
a welding gun connected to said power source/feeder, wherein said feeder supplies the inert gas and the wire to said welding gun, said welding gun comprising:
a handle configured to be grasped by an operator, said handle having first and second ends;
an input line connected to a first end of said handle, said input line configured to deliver one or both of wire and/or gas to the welding gun;
a neck operatively connected to said second end of said handle, wherein the one or both of wire and/or gas passes into said neck and out through a nozzle; and
an acoustic wave trigger secured to said handle, said acoustic wave trigger comprising a substrate having an acoustic wave cavity and a transducer mounted to said substrate, wherein said transducer is configured to generate a trapped acoustic wave within said acoustic wave cavity, said acoustic wave trigger activating the welding gun when touched by the operator, wherein a touch is detected through a measured change in impedance or decay rate of the trapped acoustic wave within said acoustic wave cavity.

17. The system of claim 16, wherein said welding gun is activated without squeezing said acoustic wave trigger.

18. The system of claim 16, wherein said acoustic wave trigger comprises a modular main body that may be selectively inserted into and removed from said handle.

19. The system of claim 16, wherein said welding gun comprises a tactile cover positioned over said acoustic wave trigger.

20. The system of claim 16, wherein said welding gun comprises at least one acoustic wave switch positioned on said handle, said at least one acoustic wave switch configured to adjust one or more of weld voltage intensity, wire feed and/or gas feed to the welding gun.
